(19) United States
(12) Patent Application Publication
(10) Pub. No.: US 2025/0037111 A1
(43) Pub. Date: Jan. 30, 2025

(54) Access Server System and Methods for Mapping and Coupling of Digital Assets

(71) Applicant: Mastercard Asia/Pacific PTE. LTD., Singapore (SG)

(72) Inventors: Karl Cheng, Singapore (SG); Phuoc Hoang Long Le, Singapore (SG); Putu Arie Ganapathi, Singapore (SG)

(21) Appl. No.: 18/225,265

(22) Filed: Jul. 24, 2023

(51) Int. Cl. G06Q 20/36; G06Q 20/38

(52) U.S. Cl. CPC G06Q 20/36; G06Q 20/389

(57) ABSTRACT

Various implementations are disclosed herein for establishing entitlement utilizing smart contracts and digital wallets. In one implementation, a card corresponding to a consumer and a blockchain wallet account address may be mapped by an access server, where the access server is configured to access a mapping service contract, and where the card comprises at least one of an associated personal account number (PAN) and an electronic application identifier (eaid) of the consumer.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Global pandemics require a reevaluation of the manner in which people interact and engage in commercial activities. Touchless experiences will be the new normal in a post-COVID world. Current solutions are not completely end-to-end and use separate tools for identity, payment and access.

For instance, current ticket verification processes utilize manual checking of an image or QR code scan. However, such ticket verification processes are often error-prone and can be counterfeited. Hence, there is a need in the art for a system that can provide seamless and secure ticket or voucher verification that would discourage scalping and would be “copy-proof”.

### SUMMARY

Described herein are various implementations of establishing entitlement utilizing smart contracts and digital wallets (e.g., crypto-wallets). In one implementation, a card (e.g., an EMV card or chip card) corresponding to a consumer and a blockchain wallet account address may be mapped by an access server (i.e., access system) (e.g., Mastercard EZaccess), where the access server is configured to securely access a mapping service contract (i.e., mapping service contract, smart contract protocol) (e.g., Mastercard EZaccess NFT protocol), and where the card comprises at least one of an (associated) personal account number (PAN) (e.g., payment card number) and an electronic application identifier (eaid) (e.g., Mastercard EzAccess Id) of the consumer.

In one implementation, a digital wallet may be coupled to an issuer computer system by a consumer device associated with a consumer, where the coupling of the digital wallet comprises associating a personal account number (PAN) or an electronic application identifier (eaid) (e.g., Mastercard EzAccess Id) of the consumer to the digital wallet.

In one implementation, a blockchain wallet account address may be provided to a merchant computer system by a consumer device associated with a consumer to map at least one of the personal account number (PAN) and the electronic application identifier (eaid) (e.g., Mastercard EzAccess Id) of the consumer to the merchant computer system.

The above referenced summary section is provided to introduce a selection of concepts in a simplified form that are further described below in the detailed description section. Additional concepts and various other implementations are also described in the detailed description. The summary is not intended to identify key features or essential features of the claimed subject matter, nor is it intended to be used to limit the scope of the claimed subject matter, nor is it intended to limit the number of inventions described herein. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a system for providing identity, payment and access services in accordance with implementations of various techniques described herein.

FIG. 2 illustrates a diagram of a system having service providers and identifier providers in accordance with implementations of various techniques described herein.

FIG. 3 illustrates a diagram of a system for generating a hashed primary account number (PAN) in accordance with implementations of various techniques described herein.

FIG. 4 illustrates a diagram of a system for mapping and coupling of digital assets in accordance with implementations of various techniques herein.

FIG. 5 illustrates an example method implementable with system 400 in accordance with implementations of various techniques herein.

FIG. 6 illustrates an example method implementable with system 400 in accordance with implementations of various techniques herein.

FIG. 7 illustrates a diagram describing categories for terminal certification for terminals working within the identity, payment and access system in accordance with implementations of various techniques described herein.

FIG. 8 illustrates a diagram of a method for providing identity, payment and access services in accordance with implementations of various techniques described herein.

FIG. 9 illustrates a diagram of a method for providing identity, payment and access services in accordance with implementations of various techniques described herein.

FIG. 10 illustrates a diagram of a system for providing access to an event in accordance with implementations of various techniques described herein.

FIG. 11 illustrates an example software data kit in accordance with implementation of various techniques described herein.

FIG. 12 illustrates an example object for reading an outcome of an EMV card event in accordance with implementations of various techniques described herein.

FIG. 13 illustrates a diagram of a system for providing transit system access in accordance with implementations of various techniques described herein.

FIG. 14 illustrates a diagram of a hardware architecture of a system for providing identity, payment and access services in accordance with implementations of various techniques described herein.

FIG. 15 illustrates a diagram of an employee onboarding system using an in-office booth in accordance with implementations of various techniques described herein.

FIG. 16 illustrates a diagram of an employee onboarding method using a user's near field chip (NFC) enabled mobile device in accordance with implementations of various techniques described herein.

FIG. 17 illustrates a diagram of a system for providing employee onboarding and employee access in accordance with implementations of various techniques described herein.

FIG. 18 illustrates a diagram of a high-level view of an identity, payment and access system in accordance with implementations of various techniques described herein.

FIG. 19 illustrates a computing system in accordance with implementations of various techniques described herein.

FIG. 20 illustrates a diagram describing categories for terminal certification for terminals working within the identity, payment and access system in accordance with implementations of various techniques described herein.

### DETAILED DESCRIPTION

Advantageously, certain inventive aspects, as described herein, incorporate emerging technologies such as smart contracts, blockchains, non-fungible tokens (NFTs), semi-fungible tokens (SFTs), cryptocurrency and/or digital wallets, and digital assets and/or tokens with inventive identity, payment, and access services. Accordingly, inventive systems and methods allow for safe and secure verification of transactions and proving entitlements utilizing smart contracts.

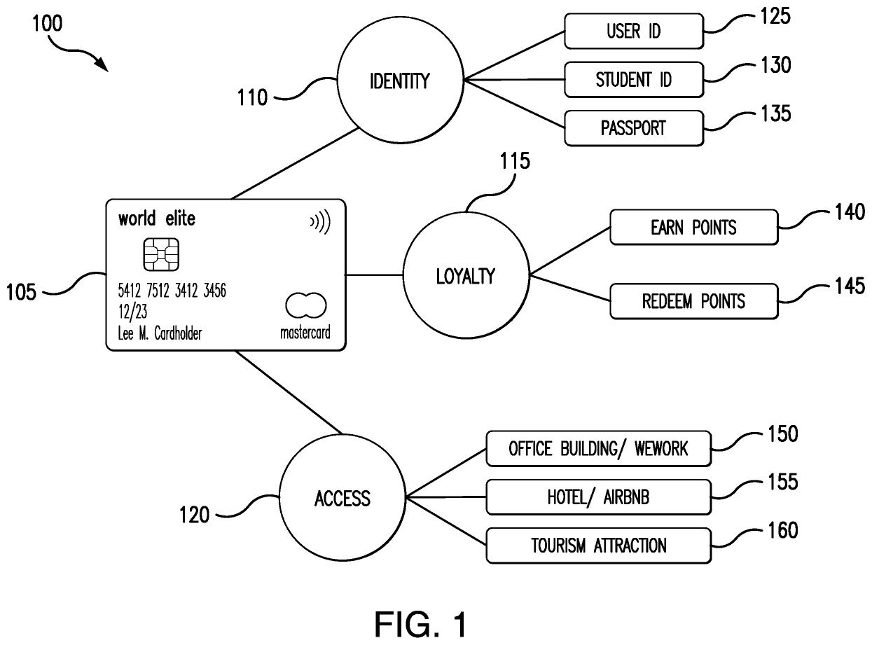

In various aspects, inventive methods provide entitlement to allow a merchant to establish ticketing and/or access to a booking system while utilizing a decentralized public blockchain (i.e., blockchain). According to certain implementations, with reference to FIGS. 1-4, an inventive assets discovery system (i.e., access system, access server) 400 is based on the mapping (e.g., coupling) of a consumer's card (e.g., 105, 305, 310, 315, 404 (as described herein) with a digital wallet 406 address (e.g., crypto wallet 406 address). In certain implementations, the digital wallet 406 may store an arbitrary amount of digital assets 408 and may also include: tokens (e.g., loyalty points), non-fungible tokens (NFTs) (e.g., tickets and/or vouchers), or semi-fungible tokens (SFTs) (e.g., loyalty profiles with voucher and loyalty points). In such implementations, a merchant 420 (i.e., a merchant computer system, computer server 420) can issue assets 418 on a public blockchain 414, and list to sell such assets 418 on a marketplace 416. Once purchased, the digital assets would be stored on a consumer's digital wallet. Moreover, an asset verifier (e.g., a gantry or merchant partner who may process loyalty rewards, etc.) would be configured to verify particular type of assets identified by blockchain, contract, and/or type identification. The asset verifier would verify ownership of the address by reading a hashed personal account number (PAN) and/or electronic application identifier (eaid) (e.g., Mastercard EzAccess Id) from the consumer's card and querying a mapping contract (e.g., a smart contract) stored on a public blockchain and securely accessible by the access server 410 (e.g., Mastercard EZaccess). In one operation, the access server (via a secure access, control, and/or utilization of the mapping contract) would contact the specific contract to retrieve the presence of the asset from the merchant by account address of the card holder (i.e., consumer).

Advantageously, asset verification can be decoupled from asset issuance, and, hence, allows for better integration of the process flow (e.g., a gantry would not need to belong to a particular ticket issuer, and would necessitate only minimal configurations to verify tickets from different sellers).

FIG. 1 illustrates a system 100 for providing identity, payment and access services. Europay, Mastercard, Visa (EMV) is a payment technology standard for providing secure transactions. An EMV card or chip card is a device that includes an embedded secure integrated circuit that can be either a secure microcontroller or equivalent intelligence with internal memory or a secure memory chip alone. The card connects to a reader with direct physical contact or with a remote contactless radio frequency interface, e.g., near field communication (NFC). With an embedded microcontroller, chip cards have the unique ability to securely store large amounts of data, carry out their own on-card functions (e.g., encryption and mutual authentication) and interact intelligently with a card reader. All EMV cards are chip cards. Chip cards can be plastic or metal cards having an embedded chip that communicates information to a payment or automated teller machine (ATM) terminal. Chip cards offer increased security.

System 100 includes implementations that are designed to enable cardholders to use any EMV contactless card or token to easily access value-added services, such as identification, loyalty and access in various use cases such as retail, smart cities, travel & hospitality.

The present system provides end-to-end implementations for identity 110, loyalty programs 115 and access 120 using the EMV standard 105 via, for example, contactless cards, tokens, mobile device digital wallet, wearable devices coupled to mobile devices. Examples related to identity 110 include passports 135, student identification 130 and user identification 125. Examples related to loyalty 115 include earning points 140 and redeeming points 145. Examples related to access include office building and/or wework systems 150, hotels and other types of rental properties 155, and attractions 160, e.g., tourism, sports or other activities. The present system brings an end-to-end, seamless touchless experience by unlocking hidden potential in existing contactless cards/tokens. Additionally, the present system, in one example, provides seamless and secure ticket or voucher verification that would discourage scalping and counterfeiting.

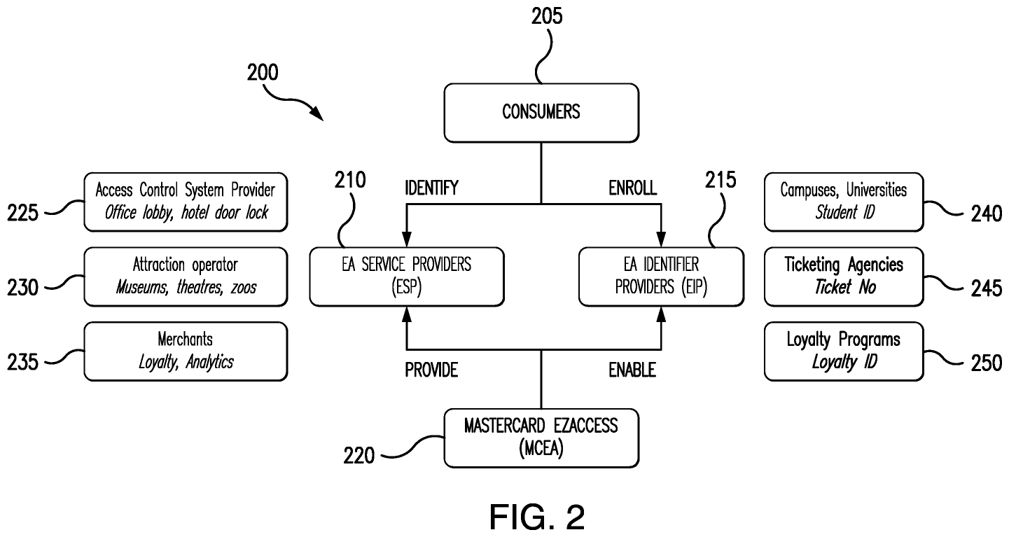

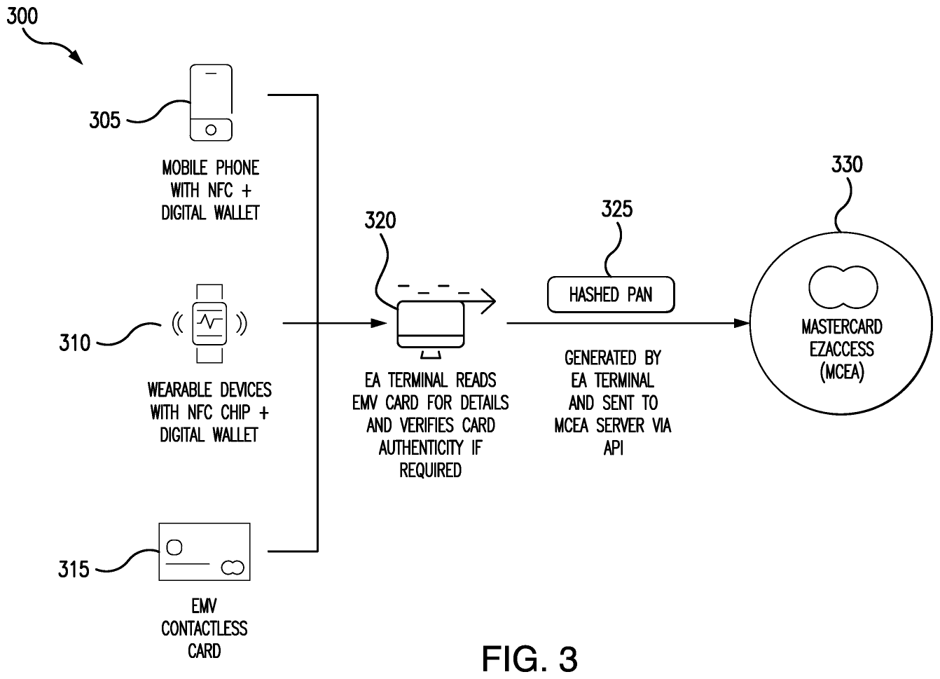

FIG. 2 illustrates a diagram of a system 200 having service providers and identifier providers. A consumer 205 (e.g., a consumer device) identifies with a service provider 210 or enrolls with an identifier provider 215. In certain implementations, the access server 220 (i.e., Mastercard EZaccess) provides service provider 210 with the ability to implement services, e.g., access control 225, entrance to attractions 230 and merchant services 235. Access control 225 system providers may include office lobbies, hotels, door locks. Attractions 230 may include museums, theatres, zoos, or any other type of attraction. Merchant services 235 may include loyalty and analytics programs. Access server 220 enables identifier provider 215 to provide student identification 240, ticketing, 245 and loyalty identification 250 services.

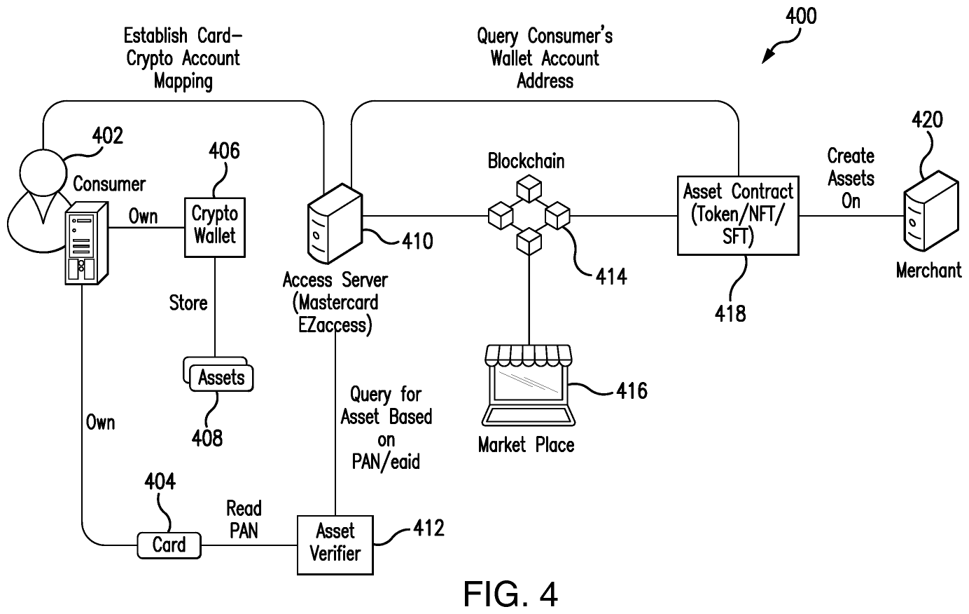

In certain implementations, when a consumer uses an EMV card, token, or digital wallet having an associated payment card number or primary account number (PAN), the access server 220 is configured to match the loyalty program identifier of the consumer with the PAN of the consumer. In other words, the access server maps/binds the loyalty program identifier to the PAN of the consumer. In other implementations, as described in later paragraphs, with reference to FIGS. 4-6, the access server 220 (matches a blockchain wallet account address of the consumer with the PAN or electronic application identifier (eaid) (e.g., Mastercard EzAccess Id) of the consumer.

FIG. 3 illustrates a diagram of a system 300 for generating a hashed PAN. Payment card information may be presented in three ways: via a mobile device 305, a wearable device 310 or a contactless EMV card 315. In certain implementations, as described with reference to FIGS. 4-6, the payment card information (as described with reference to FIG. 3) is presented as card 404.

With reference to FIG. 3, mobile device 305 may include near field communication (NFC) circuitry and digital wallet software. The digital wallet is a software-based system that securely stores users' payment information and passwords for various payment methods and websites. By using a digital wallet, users can complete purchases easily and quickly, for example, with near-field communications technology. Wearable device 310 may also include NFC circuitry and digital wallet software. In one implementation, terminal 320 reads EMV card information from EMV card 315 or via the digital wallet of mobile device 305 or wearable device 310. Terminal 320 determines the PAN from the EMV card or receives the PAN from the digital wallet of the mobile device or wearable device. In one implementation, terminal 320 verifies card authenticity. Terminal 320 generates a hashed PAN and sends the hashed PAN to the access server 330.

In one implementation, a hashed PAN or digital account number (DAN) is generated using the following method. Salt is provisioned to the terminal 320 by the access server 330. The PAN/DAN is read from the EMV card or token. A salt is random data that is used as an additional input to a one-way function that hashes data, a password or passphrase. Salts are used to safeguard PANs/DANs. A new salt is randomly generated for each PAN/DAN. In one implementation, the salt and the PAN/DAN (or a version of the PAN/DAN) are concatenated and fed to a cryptographic hash function. The hashed PAN/DAN, e.g., output hash value, (but not the original PAN/DAN) can be stored in a local memory or sent to access server 330. Hashing allows for later authentication without keeping and therefore risking exposure of the PAN/DAN if the authentication data store is compromised. In one implementation, the PAN/DAN read by terminal 320 can be 13 to 19 digits. In one implementation, the hashed PAN (PAN|SALT) or hashed DAN (DAN|SALT) can be generated by a SHA256 hash function. For the sake of simplicity, wherever the present disclosure describes implementations related to a PAN, the same methods described herein can be applied to DANs and/or tokens presented by mobile and/or wearable devices.

FIG. 4 illustrates a diagram of an assets discovery system 400 allowing for mapping and coupling of digital assets in accordance with implementations of various techniques herein. As may be appreciated, instead of using a proprietary booking system, tickets/entitlements may be represented as non-fungible tokens (NFTs), whereby such NFTs may be sold on a marketplace 416 (e.g., an NFT platform or with a basic web3 enabled website). For example, a mapping contract securely accessible (as well controllable and usable) by an access server 410 (i.e., access system) (e.g., Mastercard EZaccess) would be configured to represent such tickets as NFTs. In certain implementations, the access server 410 may be the access server 220 or 330 (with reference to FIGS. 2 and 3).

In one operation, a consumer (via a consumer device 402) would initially associate their card 404 (e.g., including personal account number (PAN) and/or an electronic application identifier (eaid)) (e.g., Mastercard EzAccess Id) with a digital wallet 406 (e.g., a crypto wallet) account address. Next, the consumer would “tap” their card 404 on a verifier terminal 412 (i.e., an asset verifier, gantry reader, gantry terminal), such that the access server 410 may query for a blockchain wallet account address (i.e., wallet address). In certain implementation, the gantry reader/gantry terminal 412 may be the terminal 320 (with reference to FIG. 3). Upon doing so, the access server 410 (e.g., via the accessed smart contract) can search on a public blockchain 414 whether the searched for wallet address includes the NFT representing a particular ticket (i.e., entitlement). For example, in certain implementations, while the mapping contract(s) and associated data can be stored in the public blockchain 414, the access server 410 is configured to invoke a function of the mapping contract on the blockchain 414 to facilitate a lookup.

In such a scenario, advantageously, the utilization of smart contracts (e.g., based on using a standard ERC 721 contract for merchant tickets) for mapping services by the access server 410 provides flexibility to a merchant system 420. In various implementations, smart contracts correspond to a program or transaction protocol written into a blockchain that can be configured to execute, control, or document events and actions according to terms of a contract or an agreement. As an advantage, in certain instances, the system 400 would provide flexibility to a merchant by using the standard ERC 721 contract for tickets, and hence, allowing for more gantry querying separate blockchains directly or to use an interface of the system 400 (e.g., that can be configured for less integration). Advantageously, by using such a smart contract protocol, a merchant system 420 is able to create a gantry smart contract (i.e., an asset contract, a digital asset) 418 that conforms to the mapping service contract (e.g., EZaccess NFT protocol as accessed, utilized, and/or controlled by access server 410 and stored on the public blockchain 414) with the capacity for additional functionalities, as described herein. Hence, interoperability can be improved for the merchant 420 or any other involved entity.

In a second example, with reference to a loyalty implementation, by using NFTs as a representation of a loyalty profile, the access server 410 can generate a mapping between the electronic application identifier (eaid) (e.g., Mastercard EzAccess Id) 404 and a loyalty profile (e.g., as described with reference to FIG. 1). For instance, when a mapped card 404 is “tapped” to a loyalty terminal (e.g., an asset verifier 412), the loyalty terminal 412 can query for a user's wallet 406 address to determine if the user owns a loyalty profile NFT. In some implementations, such a loyalty terminal 412 may be the terminal 320 (with reference to FIG. 3). Moreover, in certain cases, instead of an NFT, a semi-fungible token (SFT) may be utilized as a loyalty profile representation 418 (e.g., a digital asset, an asset contract) along with the capacity to also save a loyalty points balance. In an implementation, the SFT, as defined in ERC-1155 Multi-token Standard, allows for each token ID to represent a new configurable token type, which may have its own metadata, supply, and other attributes. In doing so, a smart contract (i.e., an asset contract) 418 would be enabled to accept a fungible portion (e.g., loyalty profile point balance) and a non-fungible portion (e.g., loyalty profile identifier) of the loyalty profile representation.

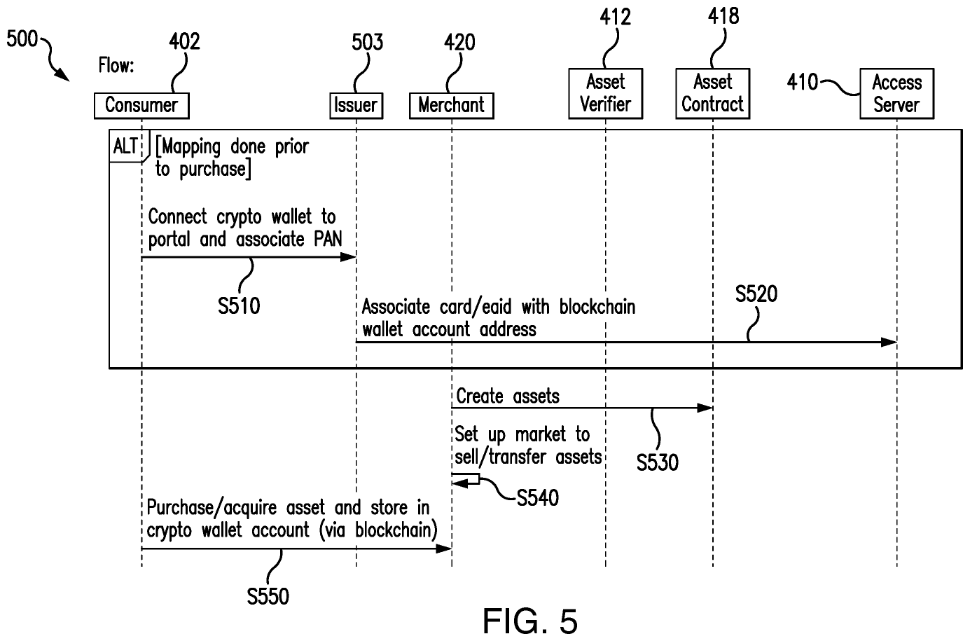

FIG. 5 illustrates an example method 600 of the assets discovery system 400 according to a first implementation. In one operation, a mapping of an asset contract 418 (e.g., token, NFT, SFT) by the system 400 is performed prior to a purchase. With reference to FIGS. 4 and 5, at step 510 (S510), at the consumer device 402 (e.g., a consumer computer, mobile phone, wearable device), a digital wallet 406 (e.g., crypto-wallet, digital assets wallet) may be coupled (connected) to a portal of an issuer 503 (i.e., an issuer computer system, issuer server) (e.g., an issuer bank portal (website/app) owned by the issuing bank), whereby a primary account number (PAN) may be associated to the digital wallet 406. At step 520 (S520), the issuer 503 (i.e., an issuer computer system, issuer server) associates a card 404 (e.g., 105) with a blockchain wallet account address (i.e., blockchain address) through a mapping service contract (e.g., Mastercard NFT/SFT Smart Contract) accessible (as well as controlled and used) by an access server 410 (e.g., Mastercard EZaccess).

In such an implementation, according to additional steps, at step 530 (S530), the merchant 420 (i.e., a merchant computer system, merchant computer) may generate (e.g., issue) one or more of the asset contracts 418 (i.e., assets, smart contracts) (e.g., token, NFT, SFT) on a public blockchain 414 (i.e., blockchain). At step 540 (S540), the merchant 420 may set up a market (i.e., a digital marketplace 416) on the blockchain 414 to list, sell and/or transfer the one or more asset contracts 418. In addition, at step 550 (S550), at the consumer device 402 (e.g., a consumer computer, mobile phone, wearable device), the consumer may acquire (e.g., purchase) the one or more asset contracts 418 and store the asset contract(s) 418 in a digital wallet 406 account (via the blockchain 414).

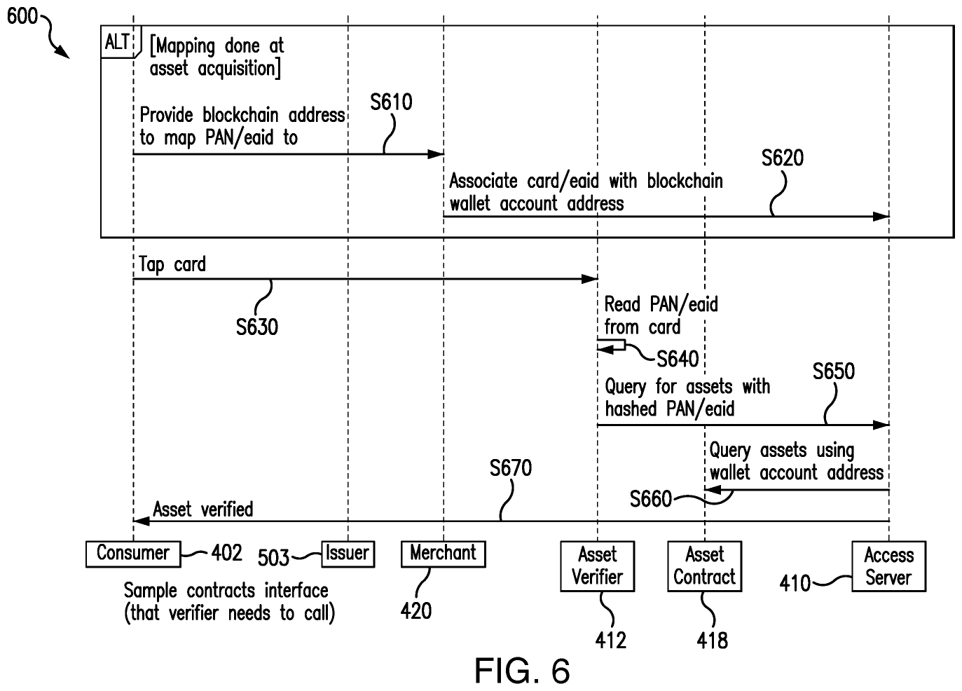

FIG. 6 illustrates an example method 600 of the assets discovery system 400 according to a second implementation. In one operation, a mapping of an asset contract 418 (e.g., token, NFT, SFT) by the system 400 is performed at asset acquisition. With reference to FIGS. 4 and 6, at step 610 (S610), at the consumer device 402 (e.g., a consumer computer, mobile phone, wearable device), the consumer can provide a blockchain wallet account address (i.e., blockchain address) to a merchant 420 (i.e., a merchant server, merchant computer system) to map a PAN (personal account number) or eaid (electronic application identifier) (e.g., Mastercard EzAccess Id). At step 620 (S620), the merchant 420 may associate a card 404 (or eaid) with a blockchain address via the mapping service contract 410 (i.e., as accessed (as well as controlled and used) by the access server) (e.g., Mastercard EZaccess).

In such an implementation, according to additional steps, at step 630 (S630), the consumer 402 may “tap” (i.e., couple) their card 404 on (or in proximity to) a verifier terminal 412 (i.e., an asset verifier/authenticator system) (e.g., a gantry, terminal system 320 with reference to FIG. 3), a merchant partner who processes loyalty points). By doing so, the verifier terminal 412 would be configured to verify/authenticate an asset or asset type (e.g., as identified by the blockchain 414, contract, and/or type id). Such configurations include one or more of the following steps: 1) at step 640 (S640), the asset verifier 412 may “read” (e.g., scan, track, processing, computing) the PAN (personal account number) or the eaid (electronic application identifier) (e.g., Mastercard EzAccess Id) from the card 404; 2) at step 650 (S650), the asset verifier 412 may query (e.g., request, “call”) the mapping contract on the access server 410 (e.g., Mastercard EZaccess) for digital assets 408, 418 with the hashed PAN (e.g., as generated with reference to the hashed PAN 325 in FIG. 3) or eaid from the card 404; 3) at step 660 (S660), the mapping contract stored on the access server 410 (e.g., Mastercard EZaccess) may query (e.g., search) for the asset contract 418 or assets 408 using the digital wallet account address associated with the PAN or eaid (e.g., Mastercard EzAccess Id); and 4) upon doing so, at step 670 (S670) the asset contract 418 or the assets 408 would be verified by the mapping contract on the access server 410 for the consumer 402. In certain implementations, the steps described with reference to the method 600 in FIG. 6 may be implemented with the system 300 in FIG. 3.

In other variations and combinations of implementations of the asset discovery system 400, the association of a digital asset 408, 418 to a card 404 involving the access server 410 (i.e., including the accessible mapping contract (i.e., Mastercard NFT Smart Contract)) would involve the initial steps of: 1) A consumer associating their card 404 (i.e., hashed PAN/eaid) with a digital account 406 (i.e., a crypto account) by a smart contract 410 (e.g., Mastercard NFT Smart Contract); 2) The consumer buying one or more tickets as a digital asset 418 (i.e., an NFT from a merchant 420 (i.e., smart contract from the merchant); 3) the coupling (e.g., “tapping”) of the card 404 on a gantry 412 (e.g., asset verification terminal).

However, in a first variation/combination, additional steps are as follows: 4) the gantry 412 would request the access server 410 (e.g., accessing, controlling, and/or utilizing the Mastercard NFT Smart Contract) for NFT tickets mapped to the tapped card 404 by providing a hashed PAN and a ticket contract address; 5) The access server 410 (e.g., accessing, controlling, and/or utilizing the Mastercard NFT Smart Contract) would “call” (e.g., connect to) the NFT contract 418 (i.e., the smart contract from the merchant) to look for ticket(s) owned by wallet address (i.e., blockchain wallet address); and 6) the access server 410 (e.g., accessing, controlling, and/or utilizing the Mastercard NFT Smart Contract) would return to the gantry 412 lists of the tickets owned by the card owner, and the gantry 412 would “check” (i.e., confirm, verify) the tickets and permit entry.

In a second variation/combination, additional steps are as follows: 4) the gantry 412 would request the ticket service contract for NFT tickets 418 (i.e., smart contract from merchant) mapped to cards by providing a hashed PAN; 5) The ticket service contract for NFT tickets 418 would “call” (e.g., connect to) the access server 410 (i.e., via the Mastercard NFT Smart Contract) with the hashed PAN to find the mapped wallet address; and 6) the access server 410 (e.g., accessing, controlling, and/or utilizing the Mastercard NFT Smart Contract) would then find NFTs owned by the wallet address returned in step 5), and would return a list of tickets owned by the card owner. Upon doing so, the gantry 412 would “check” (i.e., confirm, verify) the tickets and permit entry.

In a third variation/combination, additional steps are as follows: 4) the gantry 412 would “call” (i.e., request) the access server 410 (e.g., via Mastercard NFT Smart Contract) with a hashed PAN to find the mapped wallet address(es), and 5) the gantry 412 would request the ticket contract for NFT tickets 418 owned by the wallet address. Upon doing so, the gantry 412 would “check” (i.e., confirm, verify) the tickets and permit entry.

According to some implementations, an interface for a contract for which systems integrating with the access server 410 (e.g., Mastercard EZaccess) may include:

```
pragma solidity \hat{ }0.8.17;
interface MastercardAssetMappingContract {
  // Asset verifier onboarding to register verifier to our Mastercard
contract.
  // This verifier will verify the assets tokens.
  function registerVerifier(string memory verifierName) external returns
(uint256 verifierIdentifier);
  // Card to account mapping process happens when user enroll their card
into this program.
  // This contract will automatically create mapping to the user account
address on the respective blockchain
that the assets reside.
  function mapCardToAccount string memory hashedPan, address
userAccountAddress) external;
  // Assets retrieval.
  // Verifiers (Gantry or any Point of Sale terminal) can send a request
directly to this contract to retrieve
list of tokens based on the user hashed pan.
  function retrieveAvailableAssets(string memory hashedPan, address
assetContract, uint256 chainId) external
view returns (uint256[ ] memory tokenIds);
}
// Merchant SFT extends ERC1155
interface MerchantSFT is ERC1155 {
  function getTokensOwnedBy(address userAccountAddress) public
view returns (uint256[ ] memory tokenList);
}
```

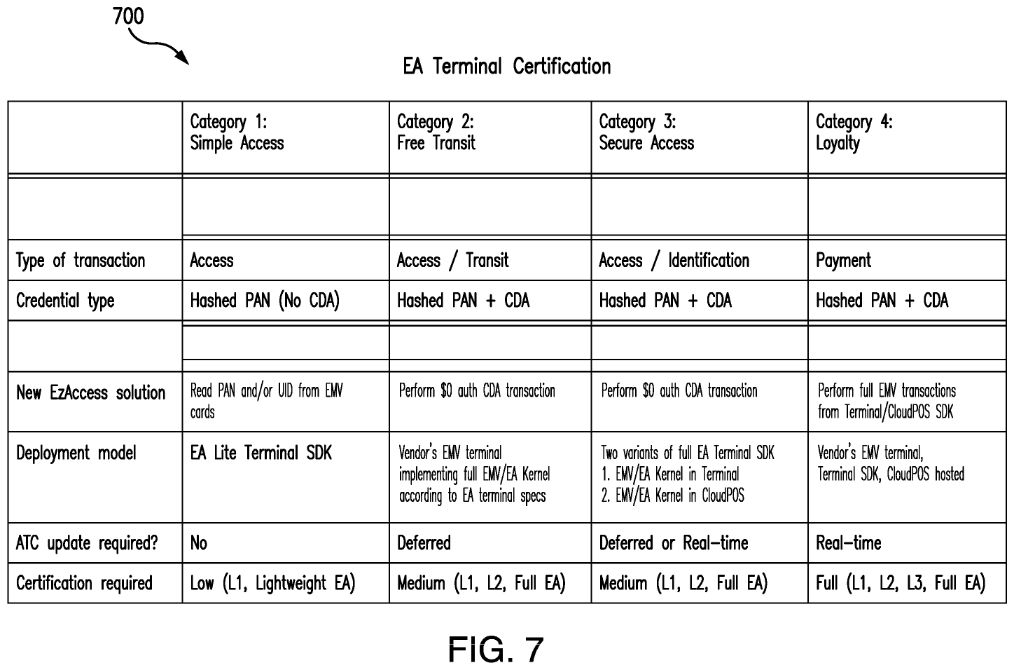

FIG. 7 illustrates a diagram 700 describing four categories for terminal certification for terminals (e.g., terminal 320, asset verifier terminal 412, gantry 412), working within the identity, payment and access system 100 and assets discovery system 400. The terminals are categorized according to the type of transaction, the credential type, the type of solution provided, deployment model version, whether an ATC update is performed, and the type of certification that is performed. Category 1 terminals provide simple access. Category 2 terminals can be used in free transit systems. Category 3 terminals can be used to provide secure access and category 4 terminals can be used to provide loyalty programs.

A Category 1 terminal is provided for simple access. The credential type for this type of system is a hashed PAN. In this implementation combined dynamic data authentication-application cryptogram generation (CDA) is not necessary. In this implementation, the terminal, (e.g., terminal 320, asset verifier terminal 412, gantry 412), reads the PAN and/or user identifier (UID) from the EMV card, mobile device or wearable device and provides access. Access can be provided by matching the hashed PAN locally or upon verification by a remote access server, e.g., access server 330, 410. The terminal can be provided using a software data kit (SDK), no application transaction counter (ATC) update is required, and the certification requirements for the terminal are low. An ATC is a counter maintained by the EMV card or digital wallet application that provides a sequential reference to each transaction. The ATC is a sequential counter managed by the contactless card or token that is used to ensure that all cryptograms produced are unique. A duplicate ATC, a decrease in ATC or a large jump in ATC values may indicate data copying or other fraud to an issuer.

A Category 2 terminal is provided for access and/or transit systems. The credential for this type of system is a hashed PAN and CDA. CDA, which is also referred to as combined data authentication, involves including the card decision among the data being signed by the card's RSA key (public key or asymmetric key algorithm). In this implementation, the terminal (e.g., terminal 320, asset verifier terminal 412, gantry 412) performs a zero dollar ($0) authorization CDA transaction. The vendor's terminal is an EMV terminal implementing full EMV access kernel according to access terminal specifications. In this implementation, ATC updates can be deferred and certification requirements are medium.

A Category 3 terminal is provided for secure access systems. Secure access systems can be directed to access and/or identification systems The credential for this type of system is a hashed PAN and CDA. In this implementation, the terminal (e.g., terminal 320, asset verifier terminal 412, gantry 412) performs a zero dollar ($0) authorization CDA transaction. The vendor's terminal SDK can be one of two types. The first terminal type for this implementation is an EMV terminal implementing a full EMV access kernel according to access terminal specifications. The second terminal type is an SDK communicating with an EMV access kernel implemented in a cloud point of sale (POS) server. In this implementation, ATC updates can be deferred or provided in real-time and certification requirements are medium.

A Category 4 terminal is provided for loyalty systems. Loyalty systems can be directed to merchant retail stores and/or payments. The credential for this type of system is a hashed PAN and CDA. In this implementation, the terminal (e.g., terminal 320, asset verifier terminal 412, gantry 412) performs full EMV transactions from the terminal and/or cloud POS SDK. The vendor's terminal can include a terminal SDK or be hosted by a cloud POS server. In this implementation, ATC updates are provided in real-time and full certification is required.

In one implementation, the terminal reads PAN numbers by using SELECT PPSE and READ RECORD command, e.g., for Category 1 transactions. In this implementation, a get processing options (GPO) command is not issued. This implementation, while simpler to implement, is less secure and subject to card cloning or emulation.

In one implementation, the terminal performs CDA with a GPO command, which will increase the ATC. In this implementation, the access server sends ATC updates to the issuer. This implementation is more secure and ensures that the card/token is genuine.

In one implementation a Cloud POS server can be leveraged to implement an EMV/EA Kernel for some use cases to reduce the terminal upgrade efforts.

In one implementation NFC data exchange performed by a terminal can be modified to perform a READ RECORD followed by a GPO. This implementation enables a single-tap hashed PAN reading mode for loyalty systems.

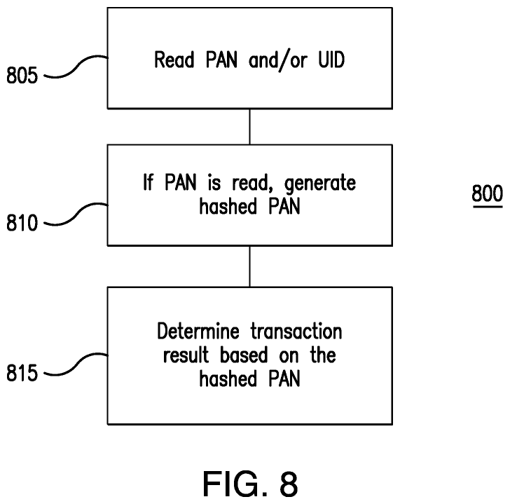

FIG. 8 illustrates a diagram of a method 800 for providing identity, payment and access services. The method 800 may be implemented in combination with the various steps of the system 400 (as described with reference to FIGS. 4-6). At block 805, a PAN and/or UID is read by the terminal, (e.g., terminal 320, terminal, asset verifier terminal 412, gantry 412). The PAN and/or UID may be read from a contactless card or via a token provided by a digital wallet present on a mobile device (or accessible via a wearable device communicatively coupled to the mobile device). At block 810, if a PAN is read, the terminal generates a hashed PAN. At block 815, the terminal determines a transaction result based on the hashed PAN. In one implementation, the transaction result is determined locally. In one implementation, the transaction result is based on a decision made by an access server, e.g., access server 330, 410. In one implementation, the transaction result is determined by performing an offline match of hashed PAN and/or UID against a locally stored whitelist. In one implementation, the terminal (e.g., terminal 320, asset verifier terminal 412, gantry 412) sends the hashed PAN and/or UID to a backend server, e.g., a server between access server 330, 410 and the terminal e.g., terminal 320, asset verifier terminal 412, gantry 412) for a decision to be determined and provided by the backend server upon matching the received hashed PAN against a whitelist. In one implementation, the service provider, e.g., the provider of identity, payment and/or access services, can optionally upload, e.g., via a backend server, the transaction data from the terminal (including UID, hashed PAN and/or other pertinent data) to the access server in real-time or as soon as possible.

The card PAN can be read, for example, using select proximity payment system environment (PPSE) command to ensure that PANs/tokens from a particular payment processor are read. Once verification that a PAN/token from the particular payment processor is presented, a read record command is given read the PAN/token. The following are example select PPSE and Read Record commands:
SELECT PPSE COMMAND: 00B2011400
READ RECORD COMMAND: 00A4040007A0000000041010

Certification for a terminal providing method 800 includes testing that the terminal can interact with the EMV card or device (mobile or wearable). Certification further includes testing to verify whether the terminal can determine that the EMV card is powered and that the flow of information can be shared. In addition, certification includes determining whether the terminal and access server can implement the transaction and data handling described in method 800.

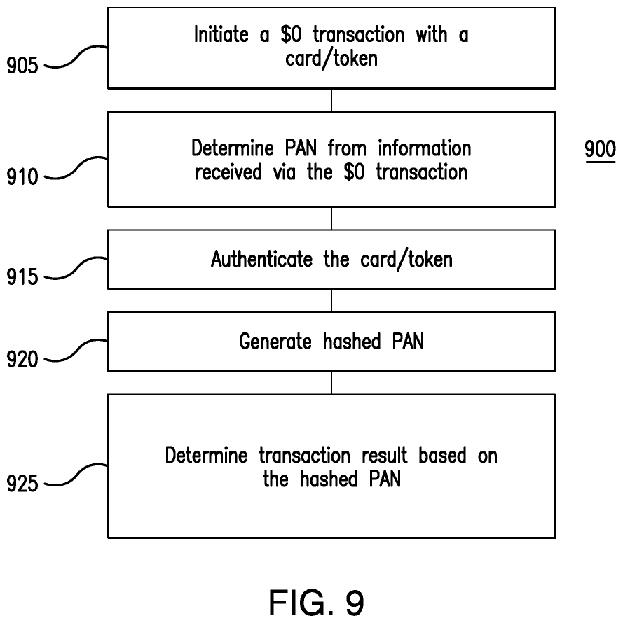

FIG. 9 illustrates a diagram of a method 900 for providing identity, payment and access services. At block 905 a $0 transaction is initiated with an EMV card or token. The EMV card may be a contactless card. Initiating a $0 transaction involves receiving a PAN and other data from the card or token. At block 910, the PAN is determined from information received via the $0 transaction. At block 915, the card/token is authenticated. In one implementation, the card/token is authenticated using CDA. CDA provides a fast and secure offline card/token authentication protocol and is supported by all contactless cards and tokens. If CDA is successful, a hashed PAN is generated at block 920. A transaction result is determined at block 925. In one implementation, the transaction result is determined locally. In this implementation, the transaction result is determined by performing an offline match of the hashed PAN against a locally stored whitelist. In another implementation, the transaction result is based on a decision made by a backend server. In this implementation, the hashed PAN is sent to the backend server for a decision on the transaction to be made by the backend server by matching the received hashed PAN against a whitelist. In one implementation, the terminal reads ATC data from the EMV card/token and provides this ATC data to the access server.

The service provider uploads, e.g., via a backend server, the transaction data from the terminal (including UID, hashed PAN and/or other pertinent data) to the access server in real-time or as soon as possible. The access server sends ATC update messages to issuers based on transaction data received from all service providers. Sending ATC updates to issuers notifies the issuer that the ATC has been incremented more than may be usual. Keeping the issuer apprised via ATC update messages avoids situations that may create unexpected declines for payment transactions.

Certification for a terminal providing method 900 includes testing that the terminal can interact with the EMV card or device (mobile or wearable). Certification further includes testing to verify whether the terminal can determine that the EMV card is powered and that the flow of information can be shared. In addition, certification includes determining whether the terminal and access server can implement the transaction and data handling described in method 900. In one implementation, an access kernel is provided. In this implementation certification includes testing to determine whether the access kernel and the card/token can communicate the correct information to allow data sharing and to allow decision-making on processing at the terminal.

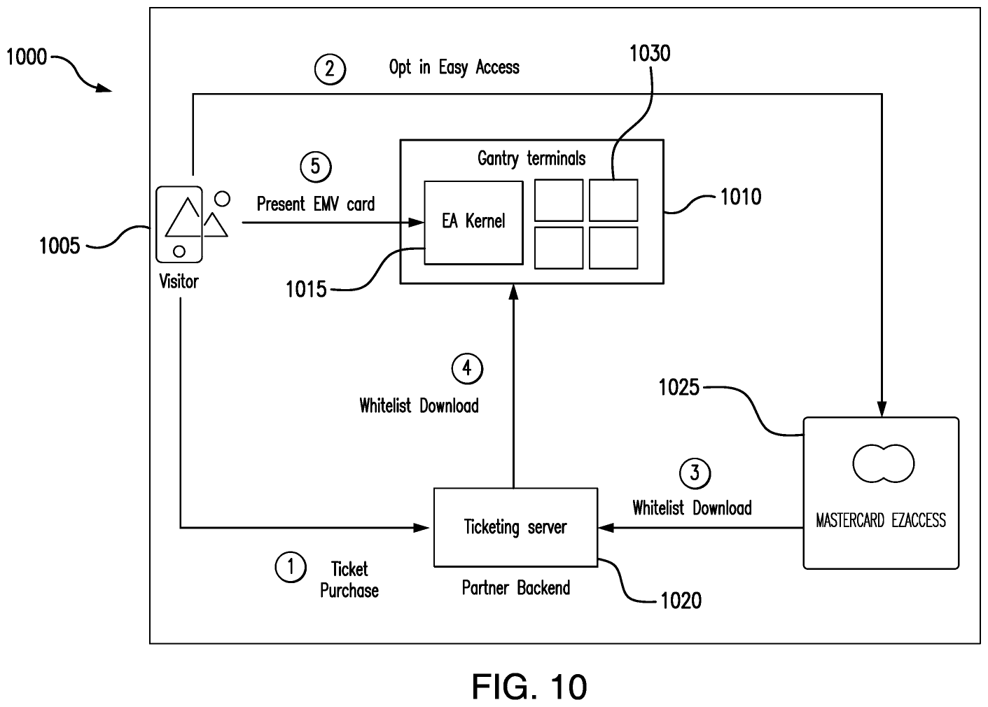

FIG. 10 is a diagram of a system 1000 for providing access to an event. In certain implementations, system 1000 may be used in combination (including with replaced elements) with system 400 (as described with reference to FIGS. 4-6). System 1000 includes an EMV card or token 1005, gantry 1010 including access kernel 1015 and gantry terminals 1030, a backend server of a service provider, e.g., ticketing server 1020, and an access server 1025. At item 1, a visitor purchases a ticket via a web-based or application-based transaction from ticketing server 1020. At item 2, upon purchasing the ticket, the visitor is presented with an option to use their EMV card or token 1005 to gain access to the event. Upon selecting the option to use the EMV card or token 1005 for the purpose of accessing the event, the user opts into the access service and the access server 1025 is notified. In one implementation, the transaction details and transaction ID are sent to the user's email, and that transaction ID is embedded in the link to opt into the access service. When the link is clicked, a web page is loaded along with the transaction ID, and the user can enter additional card details, e.g., either from a physical card or from the user's digital wallet. These hashed PANs and the transaction ID are then sent to the access server 1025. At item 3, the ticketing server 1020 downloads a whitelist, e.g., a list of eligible hashed PANs that are associated with valid ticket booking references to ticketing server 1020. At item 4, the whitelist is downloaded to gantry 1010. At item 5, when the visitor presents the EMV card/token at the gantry 1010, the PAN/token is read by access kernel 1015. Access kernel 1015 generates a hashed PAN and compares the hashed PAN to the downloaded whitelist.

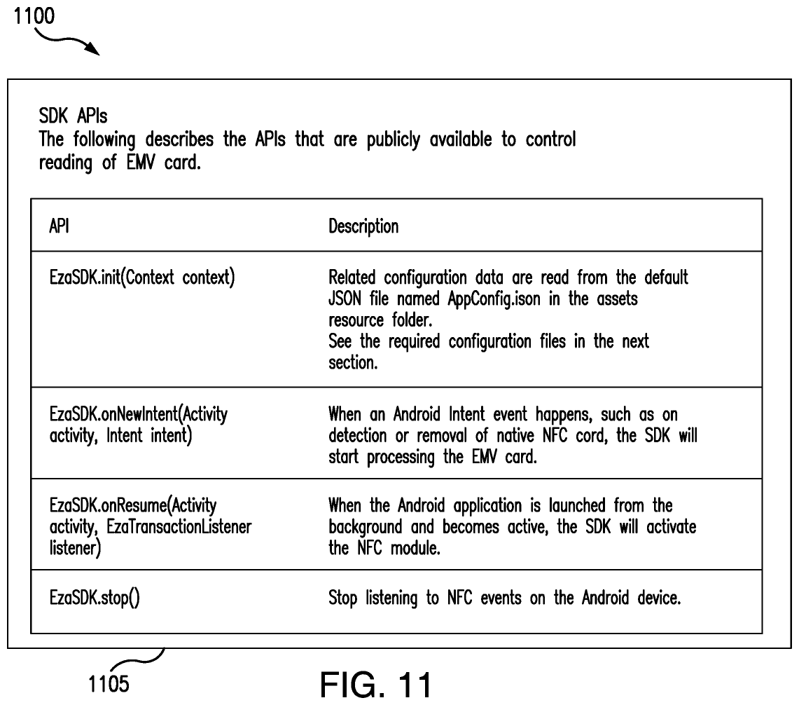

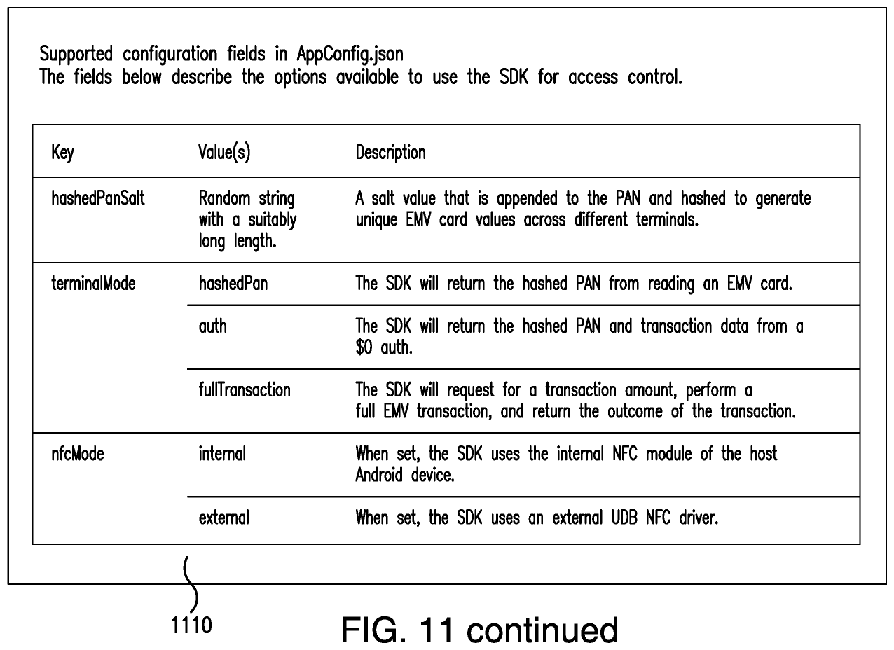

FIG. 11 shows an example SDK 1100. In particular, SDK 1100 can be used to implement terminal 320, 412, etc. and methods 500, 600, 700. Item 1105 describes application programming interfaces (APIs) that are publicly available to control the reading of an EMV card. In particular, item 805 describes the following APIs: EzaSDK.init (Context context), EzaSDK.onNewIntent (Activity activity, Intent intent), EzaSDK.onResume (Activity activity, EzaTransactionListener listener), and EzaSDK.stop( ). The EzaSDK.init (Context context) API reads related configuration data from a default JavaScript Object Notation (JSON) file named AppConfig.ison in an assets resource folder. The EzaSDK.onNewIntent (Activity activity, Intent intent) API provides that when an Android Intent event happens, such as on detection or removal of a native NFC card, the SDK will start processing the EMV card. The EzaSDK.onResume (Activity activity, EzaTransactionListener listener) API provides that when the Android application is launched from the background and becomes active, the SDK activates the NFC module. The EzaSDK.stop( ) API allows the terminal to stop listening to NFC events on an Android device.

Item 1110 describes supported configuration fields in AppConfig.json. The fields in item 1110 describe options available to use the SDK for access control. In one implementation, a hashedPanSalt is a random string having a suitably long length. The salt value is appended to the PAN and hashed to generate unique EMV card values across different terminals. A terminalMode field can be one of three values: a hashedPan, an auth, or a fullTransaction. When the hashedPan is used, the SDK returns the hashed PAN from reading an EMV card. When auth is used, the SDK returns the hashedPAN and transaction data from a $0 authorization. When fullTransaction is used, the SDK requests for a transaction amount, performs a full EMV transaction, and returns the outcome of the transaction. An nfcMode field can have an internal value or an external value. When the internal value is set, the SDK uses the internal NFC module of the host Android device. When the external value is set, the SDK uses an external universal serial bus (USB) NFC driver.

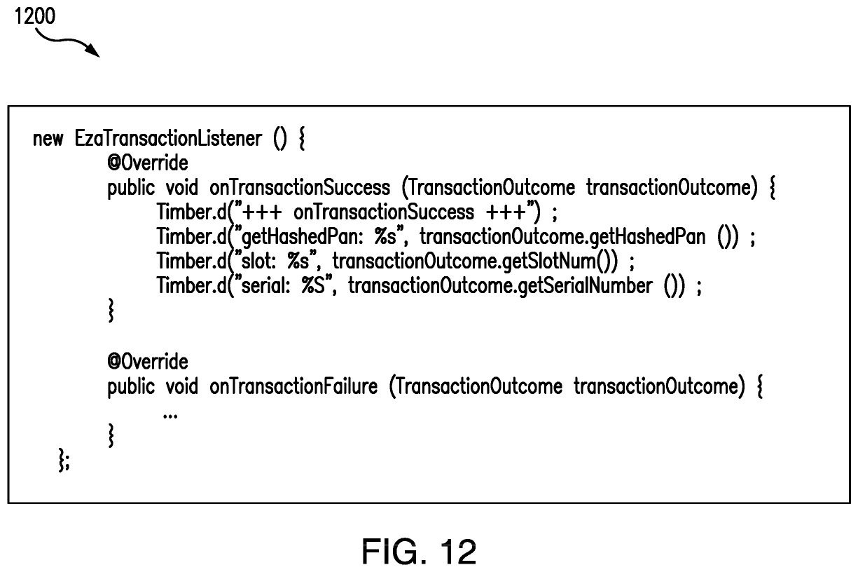

FIG. 12 illustrates an example object 1200 for reading an outcome of an EMV card event. Reading the outcome of an EMV card event can be implemented by using the EzaTransactionListener according to two methods, a success or a failure. All transaction information whether a success or a failure, can be retrieved from the TransactionOutcome object.

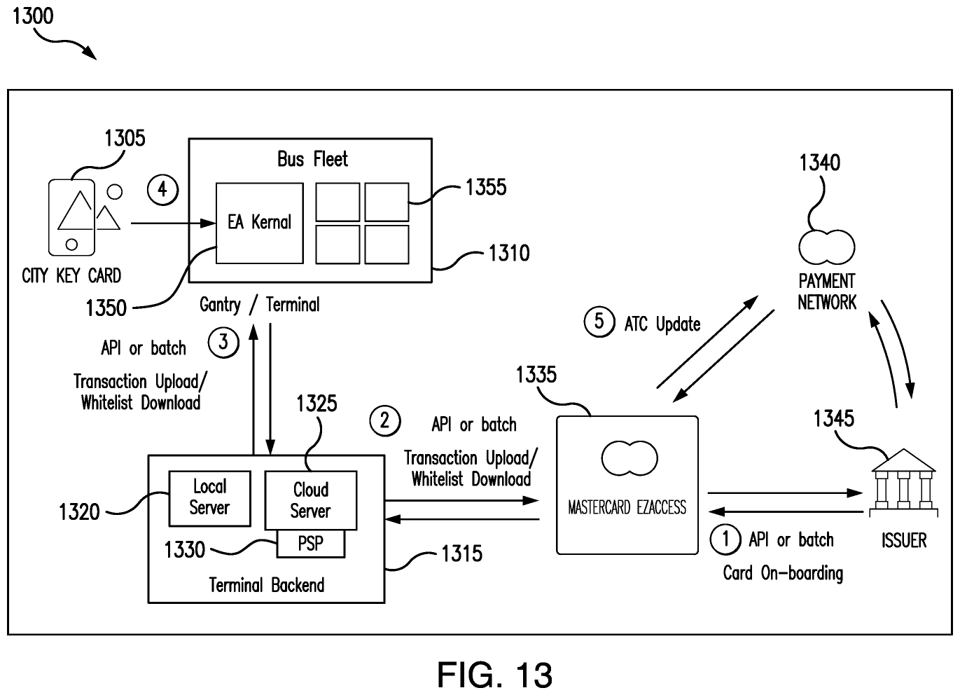

FIG. 13 is a diagram of a system 1300 for providing transit system access. In certain implementations, system 1300 may be used in combination (including with replaced elements) with system 400 (as described with reference to FIGS. 4-6). System 1300 includes a transportation key card 1305, gantry/terminal 1310 coupled to one or more fleet terminals 1355 and access kernel 1350, a terminal backend 1315 of a transit system provider that includes a local server 1320, a cloud server 1325 and PL/SQL Server Pages (PSP), an access server 1335, a payment network 1340, and an issuer 1345.

At item 1, issuer 1345 onboards key cards onto access server 1335 as hashed PANs. At item 2, vendor, e.g., terminal backend 1315, downloads, from access server 1035, a list of eligible hashed PANs, e.g., a whitelist. Terminal backend 1315 also uploads transaction records to access server 1335. At item 3, when a passenger presents a transportation key card at transportation terminals, e.g., gantry 1310 or fleet terminals 1355, entry details are stored in a memory of the gantry/terminal 1310, 1355. Gantry/terminal 1310, 1355 supports internal and external expandable storage capability, e.g., SD cards. A hashed PAN is generated for the transportation key card and CDA authentication is performed to ensure that the card is genuine. In this implementation, the ATC counter is incremented. At item 4, hashed PANs are synchronized to the fleet and historical transaction data is uploaded. At item 5, access server 1335 sends ATC updates to the issuer 1345 via the payment network 1040.

The implementation of FIG. 13 describes a closed-loop platform where the transit system access provider can migrate to an open-loop platform. In closed-loop transit, fare is purchased beforehand and stored on a non-EMV card. Fare transactions are synchronized with a local server, e.g., at the end of the day. The migration to open-loop transit with EMV-enabled gantry terminals allows them to be connected to cloud servers, which are connected to a Payment Service Provider (PSP) to allow near real-time payment (or end of day) transactions. Local server 1320 supports gantry terminals in closed-loop transit, and cloud server 1325 supports open-loop transit.

In one implementation, certain hashed PANs are allowed for free transit. These hashed PANs are stored in a whitelist. The whitelist is transferred from Access Server 1335 and stored in gantry terminals 1350. During tap in at the gantry, the card transaction data is stored in the gantry terminal, but at end of day reconciliation, the card transaction data is synchronized to the backend 1315, and forwarded to Access Server 1334.

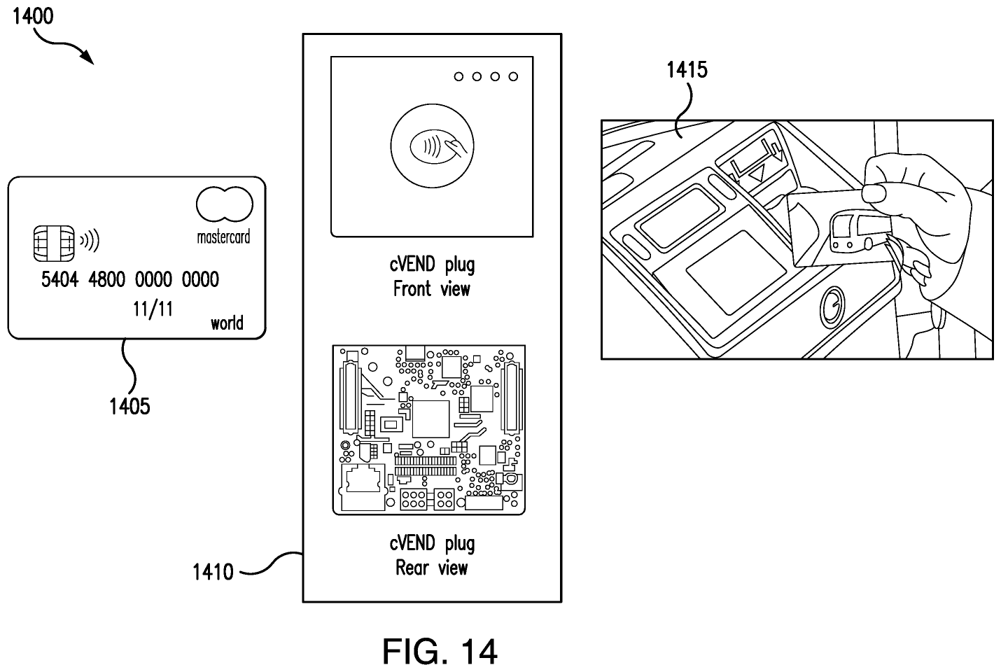

FIG. 14 is a diagram of a hardware architecture of a system 1400 for providing identity payment and access services. In certain implementations, system 1400 may be used in combination (including with replaced elements) with system 400 (as described with reference to FIGS. 4-6). A card or token 1405 (via mobile and/or wearable device) is presented to a terminal 1410. Terminal 1410 can store 1 MB of 100 hashed PANs as a whitelist. In addition, terminal 1410 can send application protocol data unit (APDU) commands over any NFC to read card data. A SHA256 algorithm can be applied to the card data to determine the hashed PAN. The determined hashed PAN can be compared against the whitelist. Terminal 1410 can store card and entry details. In one implementation, terminal 1410 includes a central processing unit (CPU) memory having at least 128 MB random access memory (RAM) and 256 MB flash memory. In one implementation, removable micro secure digital (SD) memory is supported. Item 1415 shows the hardware integration of terminal 1410 with a gantry. In this particular implementation, a sticker can be provided on the gantry to indicate that only compatible key cards can be tapped. A speaker can be provided to give feedback to passengers on approval or denial of entry. A display can also be provided to give feedback on approval or denial of entry.

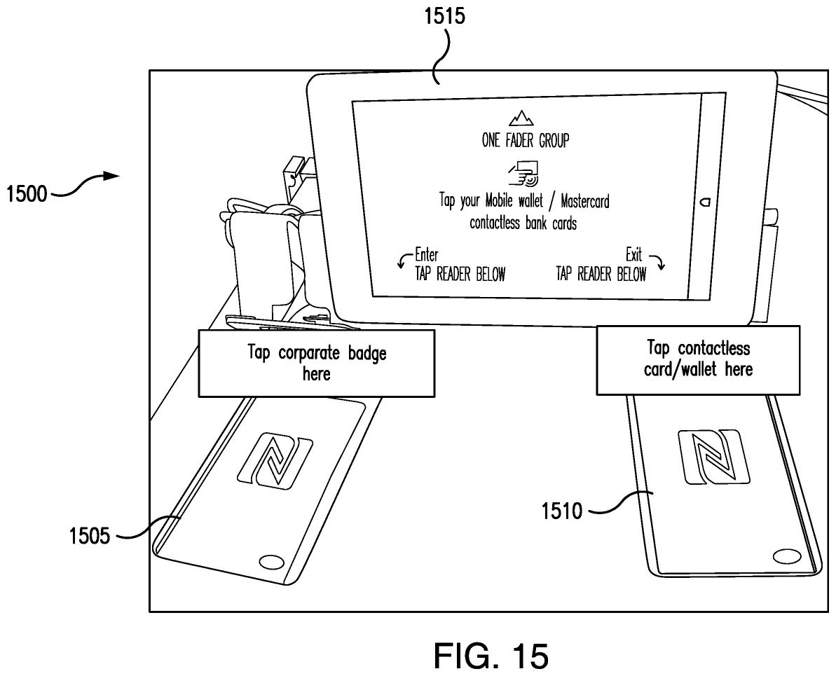

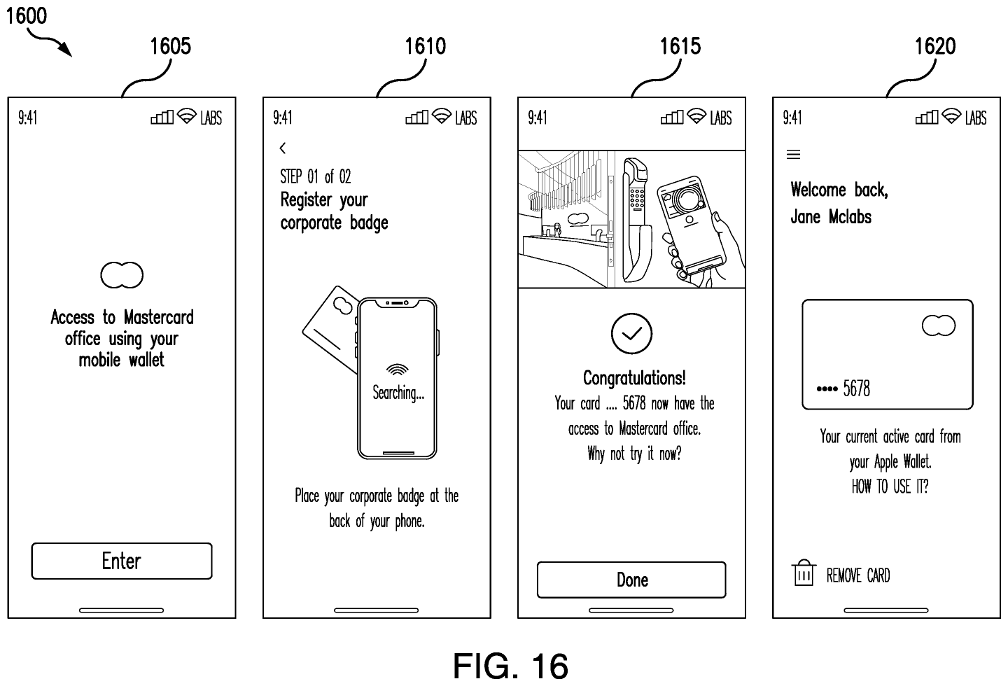

FIG. 15 is a diagram of an employee onboarding system 1500 using an in-office booth. In certain implementations, system 1500 may be used in combination (including with replaced elements) with system 400 (as described with reference to FIGS. 4-6). A self-onboarding booth can be implemented at an office lobby or near a reception area. Staff members begin the onboarding process by tapping their corporate badge at a card reader 1505 coupled to a terminal 1515. The staff member would then tap their contactless physical/digital card on a second card reader 1510 to register for access. Staff may begin using their EMV card, mobile device, or wearable device, to access a building once onboarding is complete.

FIG. 16 is a diagram of an employee onboarding method 1600 using a user's NFC-enabled mobile device. In certain implementations, method 1600 may be used in combination (including with replaced elements) with methods 500, 600 (as described with reference to FIGS. 5-6). At block 1605, the user accesses an employee onboarding application on their mobile device. At block 1610, the corporate badge of a user is registered when placed the near the NFC reader of the mobile device. When onboarding is complete, a notification is provided via a success screen at item 1615. The user is now able to gain access to the site using their mobile device at item 1620.

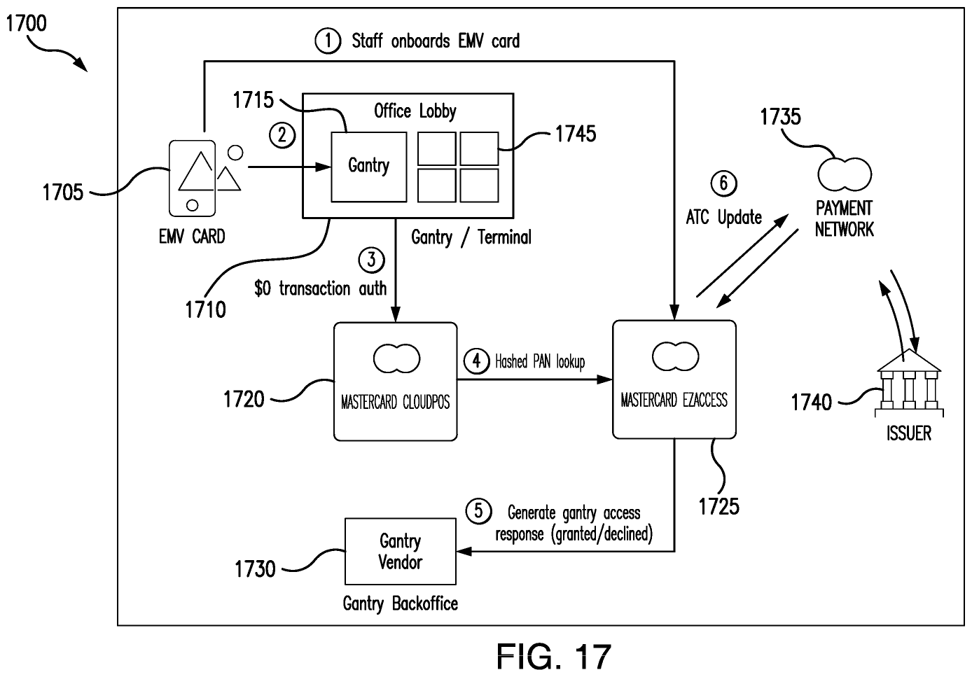

FIG. 17 is a diagram of a system 1700 for providing employee onboarding and employee access. In certain implementations, system 1700 may be used in combination (including with replaced elements) with system 400 (as described with reference to FIGS. 4-6). System 1700 includes an EMV card 1705, gantry/terminal 1710 having a gantry 1715 and one or more terminals 1745, a gantry backoffice 1430, a cloud point of sale (POS) server 1720, an access server 1725, a payment network 1735, and an issuer 1740. In one implementation, the one or more terminals 1745 include terminals 1705, 1715.

At item 1, a user onboards a corporate ID badge and EMV card to access server 1725 as described in FIG. 12 or FIG. 13. At item 2, the EMV card is presented at gantry 1715. At item 3, Cloud POS 1720 initiates a $0 transaction over a secure network. At item 4, Cloud POS 1720 reads the hashed PAN from the EMV card and performs a lookup of access rules from access server 1725. At item 5, access server 1725 requests the gantry vendor, e.g. gantry backoffice 1730, to generate a gantry access response, e.g., granted or declined. The gantry access response is then sent from the gantry backoffice 1730 to the gantry terminal 1710. At item 6 transaction cryptogram data is sent to payment network 1735 to update the ATC.

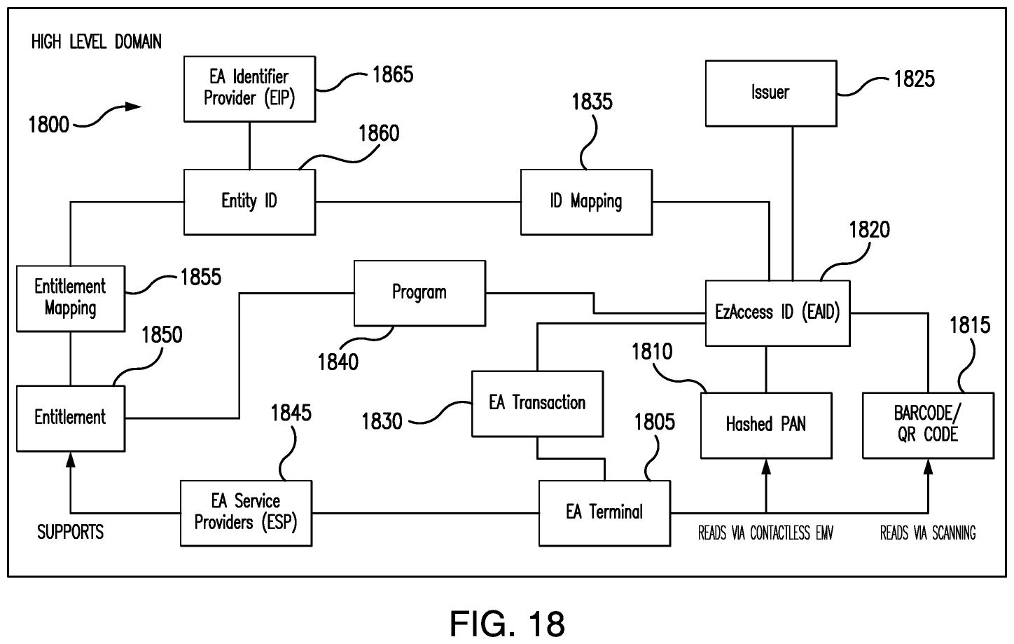

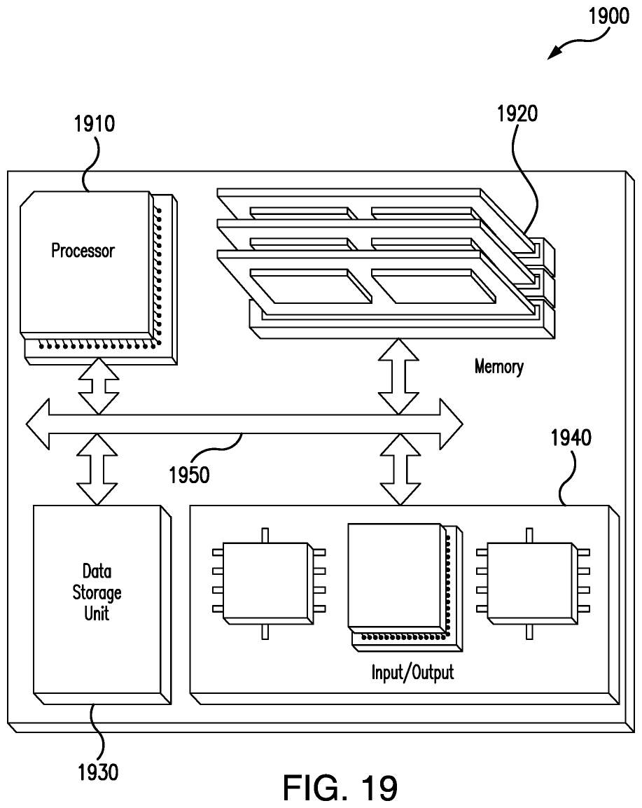

FIG. 18 is a diagram of a high-level view 1800 of the identity, payment and access system. In certain implementations, system 1800 may be used in combination (including with replaced elements) with system 400 (as described with reference to FIGS. 4-6). The system uses an access ID 1820 to implement a variety of identity, loyalty and access services. The access ID 1820 is mapped to a variety of items including, but not limited to, transaction data 1830, hashed PANs 1810, Barcode and/or QR codes 1815, program data 1840 and IDs 1835. Transaction data 1830, hashed PANs 1810 and Barcodes/QR codes 1815 can be provided by a terminal 1805. Various data associated with the access ID 1820 can be provided to an issuer 1825. Service providers 1845 can provide entitlements 1850 and entitlement mapping 1855 via the use of terminal 1805. Identifier provider 1865 can provide an entity ID 1580 that is mapped 1835 to the access ID 1820 and/or entitlements 1855.

The present system provides a variety of advantages. QR codes, bar codes and vendor cards can easily be duplicated. In certain instances, the present disclosure provides a system that can read PAN and serial number from physical and digital EMV cards. The hardware of the present disclosure is low-cost and uses existing gantries and/or USB NFC devices. Implementations of the present disclosure are built on top of existing highly secure and proven EMV payment standards, provides a unified digital-first experience for consumers across different domains, and provides more data points for merchants.

FIG. 19 is a block diagram of a hardware configuration 1900 operable as a device in an identity, payment and access system 100 as well as the asset discovery system 400. Hardware configuration 1900 may be utilized to implement one or more of elements as described with reference to FIGS. 1-18. The hardware configuration 1900 can include a processor 1910, a memory 1920, a storage device 1930, and an input/output device 1940. Each of the components 1910, 1920, 1930, and 1940 can, for example, be interconnected using a system bus 1950. The processor 1910 can be capable of processing instructions for execution within the hardware configuration 1900. In one implementation, the processor 1910 can be a single-threaded processor. In another implementation, the processor 1910 can be a multi-threaded processor. The processor 1910 can be capable of processing instructions stored in the memory 1920 or on the storage device 1930.

The memory 1920 can store information within the hardware configuration 1900. In one implementation, the memory 1920 can be a computer-readable medium. In one implementation, the memory 9620 can be a volatile memory unit. In another implementation, the memory 1920 can be a non-volatile memory unit.

In some implementations, the storage device 1930 can be capable of providing mass storage for the hardware configuration 1900. In one implementation, the storage device 1930 can be a computer-readable medium. In various different implementations, the storage device 1930 can, for example, include a hard disk device/drive, an optical disk device, flash memory or some other large capacity storage device. In other implementations, the storage device 1930 can be a device external to the hardware configuration 1900. The input/output device 1940 provides input/output operations for the hardware configuration 1900.

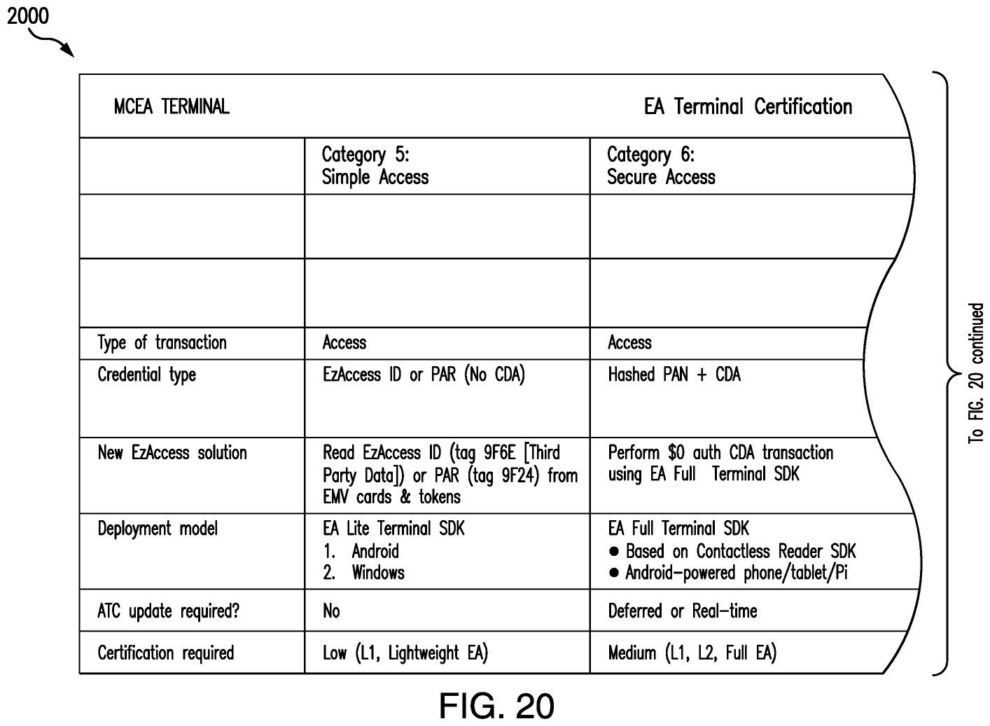

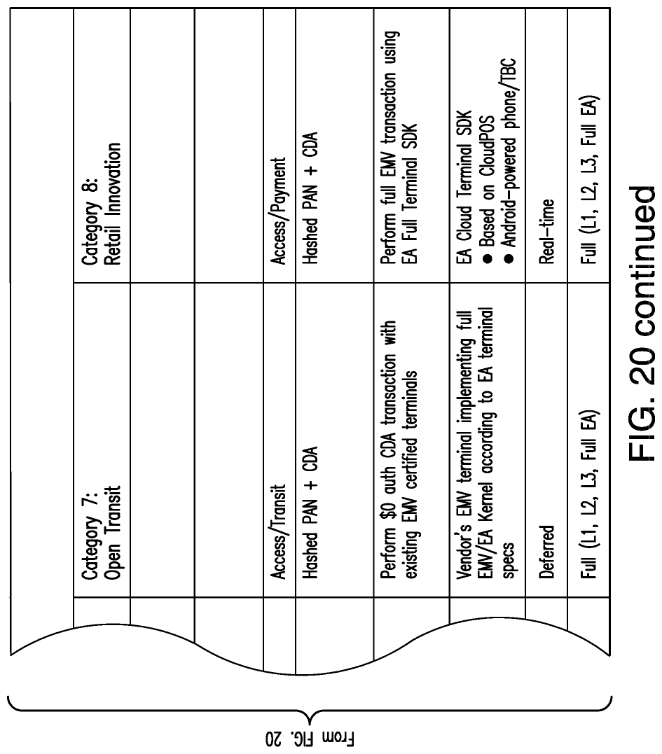

FIG. 20 illustrates a diagram 1200 describing four categories (in addition to the categories described in FIG. 7) for terminal certification for terminals (e.g., terminal 320, asset verifier terminal 412, gantry 412) working within the identity, payment and access system 100 or system 400. The terminals are categorized according to the type of transaction, the credential type, the type of solution provided, deployment model version, whether an ATC update is performed, and the type of certification that is performed. Category 5 terminals provide simple access. Category 6 terminals can be used to provide secure access. Category 7 terminals can be used to provide open transit and Category 8 terminals can be used to provide retail innovation programs.

As mentioned above, Category 5 terminal is provided for simple access. The credential type for this type of system is an access ID or a payment account reference (PAR). In this implementation, combined dynamic data authentication-application cryptogram generation (CDA) is not necessary. Further, the terminal (e.g., terminal 320, asset verifier terminal 412, gantry 412) reads the access ID or PAR from the EMV card, mobile device or wearable device and provides access. In one implementation, the access ID can be read using a third party data and the PAR can be read via an EMV card or token. In another implementation, third party data can be provided via tag 9F6E and the PAR can be provided via tag 9F24. Access can be provided by matching the access ID or PAR locally or upon verification by a remote access server, e.g., access server 330. The terminal can be provided using a software data kit (SDK), no application transaction counter (ATC) update is required, and the certification requirements for the terminal are low. The terminal SDK can be implemented on a computer operating system or implemented on a mobile device operating system, e.g., for a phone, tablet or similar mobile device.

As mentioned above, Category 6 terminal is provided for secure access systems. Secure access systems can be directed to access and/or identification systems. The credential for this type of system is a hashed PAN and CDA. In this implementation, the terminal, e.g., terminal 320, performs a zero dollar ($0) authorization CDA transaction. The vendor's terminal SDK is an EMV terminal implementing a full EMV access kernel according to access terminal specifications. The full terminal SDK can be based on a contactless reader SDK or implemented in a mobile device operating system, e.g., for a phone, tablet or similar mobile device. In this implementation, ATC updates can be deferred or provided in real-time and certification requirements are medium.

As mentioned above, Category 7 terminal is provided for access and/or transit systems. In particular, the Category 7 terminal is provided for an open transit system. The credential for this type of system is a hashed PAN and CDA. CDA, which is also referred to as combined data authentication, involves including the card decision among the data being signed by the card's RSA key (public key or asymmetric key algorithm). In this implementation, the terminal (e.g., terminal 320, asset verifier terminal 412, gantry 412) performs a zero dollar ($0) authorization CDA transaction. The vendor's terminal is an EMV terminal implementing full EMV access kernel according to access terminal specifications. In this implementation, ATC updates can be deferred and full certification is required.

As mentioned above, Category 8 terminal is provided for access and/or payment systems. In particular, the Category 8 terminal is provided for retail innovation systems. Retail innovation can be directed to merchant retail stores and/or payments. The credential for this type of system is a hashed PAN and CDA. In this implementation, the terminal (e.g., terminal 320, asset verifier terminal 412, gantry 412) performs full EMV transactions from the terminal and/or cloud POS SDK. The vendor's terminal can include a terminal SDK implemented on a mobile device running a mobile device operating system or be hosted by a cloud POS server. In this implementation, ATC updates are provided in real-time and full certification is required.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
mapping, by an access server, a card corresponding to a consumer and a blockchain wallet account address, wherein the access server is configured to access a mapping service contract, and wherein the card comprises at least one of a personal account number (PAN) and an electronic application identifier (eaid) of the consumer.

2. The method of claim 1, wherein the mapping of the card is performed prior to a digital asset transaction.

3. The method of claim 2, further comprising:
coupling, by a consumer device associated with the consumer, a digital wallet to an issuer computer system, wherein the coupling of the digital wallet comprises associating the personal account number (PAN) of the consumer to the digital wallet.

4. The method of claim 3, further comprising:
generating, by a merchant computer system, one or more asset contracts corresponding to respective digital assets on a blockchain.

5. The method of claim 4, wherein the respective digital assets comprise: non-fungible tokens (NFTs), semi-fungible tokens (SFTs), or tokens.

6. The method of claim 4, further comprising:
listing, by the merchant computer system, on a digital marketplace, the one or more asset contracts on the blockchain.

7. The method of claim 6, further comprising:
acquiring, by the consumer via the consumer device, the one or more asset contracts, wherein the one or more assets are configured to be stored on the digital wallet.

8. The method of claim 1, wherein the mapping of the card is performed concurrent to a digital asset transaction.

9. The method of claim 8, further comprising:
providing, by a consumer device associated with the consumer, the blockchain wallet account address to a merchant computer system, to map the at least one of the personal account number (PAN) and the electronic application identifier (eaid) of the consumer to the merchant computer system.

10. The method of claim 8, further comprising:
coupling, by the consumer, the card to an asset verifier terminal.

11. The method of claim 10, further comprising:
processing, by the asset verifier terminal, the personal account number (PAN) or the electronic application identifier (eaid) from the card; and
generating a hashed PAN.

12. The method of claim 11, further comprising:
requesting, by the asset verifier terminal, the mapping service contract stored on the access server for one or more digital assets associated with the hashed PAN or the electronic application identifier.

13. The method of claim 12, further comprising:
searching, by the access server, for the one or more digital assets using the blockchain wallet account address.

14. The method of claim 13, further comprising:
verifying, by the access server, the one or more digital assets.

15. The method of claim 11, wherein the one or more digital assets comprise: non-fungible tokens (NFTs), semi-fungible tokens (SFTs), or tokens.

16. The method of claim 15, wherein the one or more digital assets comprise an NFT or SFT corresponding to a loyalty profile.

17. The method of claim 1, wherein the card is a chip card corresponding to a Europay, Mastercard, Visa (EMV) card.

18. The method of claim 1, wherein the card is configured for presentation via a mobile device, a wearable device, or a contactless EMV card.

19. A method comprising:
coupling, by a consumer device associated with a consumer, a digital wallet to an issuer computer system, wherein the coupling of the digital wallet comprises associating a personal account number (PAN) or an electronic application identifier (eaid) of the consumer to the digital wallet.

20. A method comprising:
providing, by a consumer device associated with a consumer, a blockchain wallet account address to a merchant computer system, to map at least one of the personal account number (PAN) and the electronic application identifier (eaid) of the consumer to the merchant computer system.
